(19) United States
(12) Patent Application Publication
(10) Pub. No.: US 2008/0249926 A1
(43) Pub. Date: Oct. 9, 2008

(54) COLLECTION AND RESERVE SYSTEMS AND METHODS

(75) Inventors: Michael L. Sgaraglio, Massapequa Park, NY (US); Linda J. Russo, S. Setauket, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/697,772

(22) Filed: Apr. 9, 2007

(51) Int. Cl. G06Q 40/00

(52) U.S. Cl. 705/39

(57) ABSTRACT

Methods, systems, and machine-readable media are disclosed for handling unfunded financial transactions. According to one embodiment, information related to a transaction can be received. One or more rules can be applied to the information related to the transaction and a determination can be made as to whether payment of the transaction is doubtful based on application of the one or more rules. Applying the one or more rules to the from a set of rules based on a source of the information related to the transaction, a type of the transaction, identity of one or more parties to the transaction, or other information related to the transaction. In response to determining that payment of the transaction is doubtful, a portion of an account receivable corresponding to the transaction can be written off.

### BACKGROUND OF THE INVENTION

Embodiments of the present invention relate generally to financial transactions. More specifically, embodiments of the present invention relate to methods and systems for reducing risk associated with handling unfunded financial transactions.

Various types of financial transactions, including for example consumer purchases or payments made using credit cards, debit cards, checks, or other instruments other than cash, typically involve a number of different entities. For example, the primary parties to the transaction include the consumer and the merchant or other supplier of the goods or services being purchased or paid for. Also included is the financial institution issuing the instrument being used, often referred to as the issuing financial institution. An acquirer can act as an intermediary between the issuing financial institution and the merchant.

For example, a typical credit card transaction in which a consumer makes a purchase from a merchant using a credit card involves the following steps. First, the merchant calculates the amount of the transaction or purchase and seeks payment from the cardholder. The cardholder then presents the merchant with his/her credit card. The merchant then runs the credit card through a point of sale terminal. The point of sale terminal captures credit card and sales information and sends such information together with an authorization request to the acquirer. The acquirer, in turn, processes the information received from the point of sale terminal and forwards any relevant information and the authorization request to the issuing financial institution. The issuing financial institution processes the relevant information and the authorization request to determine whether the transaction should be authorized. The issuing financial institution then sends an approval or denial code back to the acquirer. The acquirer relays the approval or denial code to the point of sale terminal for use by the merchant. If the transaction is authorized, the cardholder is allowed to consummate the transaction with the merchant. Typically, at a later time, the accounts maintained by the issuer and the acquirer are settled and reconciled. The end result is that the issuer transfers the transaction amount minus a fee to the acquirer. The acquirer then deducts a fee from the amount received from the issuer. The remaining amount is then transferred by the acquirer to the merchant's account. The issuer also bills the cardholder for the transaction amount by sending the cardholder a credit card statement. The cardholder is typically billed by the issuer on a monthly cycle.

A problem can arise however for the acquirer because of the delay between the authorization of the transaction and the payment by the issuing financial institution. That is, while the acquirer has authorized the transaction, the issuing financial institution has not yet funded the transaction. Until the transaction is actually funded by the issuing financial institution, the acquirer maintains a financial liability for the transaction. If, for some reason, the transaction remains unfunded, the acquirer risks suffering a loss on the transaction. Hence, there is a need for improved methods and systems for handling unfunded financial transactions.

### BRIEF SUMMARY OF THE INVENTION

Methods, systems, and machine-readable media are disclosed for handling unfunded financial transactions. According to one embodiment, a method for processing unfunded financial transactions can comprise receiving information related to a transaction. The transaction can correspond to at least a portion of an account receivable. One or more rules can be applied to the information related to the transaction and a determination can be made as to whether payment of the transaction is doubtful based on application of the one or more rules. Applying the one or more rules to the information related to the transaction can further comprise selecting the one or more rules from a set of rules based on a source of the information related to the transaction, a type of the transaction, identity of one or more parties to the transaction, or other information related to the transaction. In response to determining that payment of the transaction is doubtful the portion of the account receivable corresponding to the transaction can be written off.

The method can also include maintaining a funded reserve account related to a party to the transaction. In such a case, writing off the portion of the account receivable corresponding to the transaction can further comprise debiting the reserve account an amount equal to the portion of the account receivable written off, recalculating a balance of an open invoice related to the transaction, updating a general ledger in which the account receivable is recorded to indicate write off of the transaction, and updating the account receivable to indicate write off of the transaction. The general ledger in which the account receivable is recorded may be updated, for example, as part of a periodic batch process.

In some cases, the method can include receiving information related to the transaction indicating payment of at least a portion of the transaction. In such a case, the method can include crediting the reserve account an amount equal to the payment, updating the general ledger in which the account receivable is recorded, flagging an accounts receivable transaction related to the payment as a return, and updating the accounts receivable with the flagged accounts receivable transaction. Updating the general ledger in which the account receivable is recorded can be performed, for example, as part of a periodic batch process.

According to one embodiment, maintaining the funded reserve account can further comprise determining whether a balance of the reserve account falls below a minimum amount designated for the reserve account and, in response to determining the balance of the reserve account falls below the minimum amount designated to the reserve account, recovering an amount to replenish the reserve account and crediting the reserve account for the amount recovered. Alternatively or additionally, maintaining the reserve account can comprise determining whether interest is earned on the reserve account. Determining whether interest is earned on the reserve account can be based on applying a rule of the one or more rules. In response to determining interest is earned on the reserve account, an amount of interest earned can be determined. Determining the amount of interest earned can be based on a table of information related to the reserve account. The interest earned can be handled or applied based on a rule of the one or more rules. For example, handling the interest can comprise returning the interest to the party to the transaction or crediting the amount of interest to the reserve account.

The method can also include, determining whether to charge a write off fee for the transaction. In response to determining the charge the write off fee for the transaction, determining the write off fee and debiting the reserve account an amount equal to the write off fee. Determining whether to charge a write off fee can be based on applying a rule of the one or more rules. The write off fee can be determined based of a table of information related to the party to the transaction.

According to one embodiment, the method can additionally or alternatively include reporting information related to the transaction. Reporting the information related to the transaction can comprise providing the information to a collector.

According to another embodiment, a system for processing an unfunded financial transaction can comprise a repository having stored therein a plurality of rule sets. At least one rule set of the plurality of rule sets can be associated with a party to the financial transaction. A processor can be communicatively coupled with the repository. A memory can be communicatively coupled with and readable by the processor. The memory can have stored therein a series of instruction which, when executed by the processor, cause the processor to receive information related to the transaction. The transaction can correspond to at least a portion of an account receivable. One or more rules can be applied to the information related to the transaction and a determination can be made as to whether payment of the transaction is doubtful based on application of the one or more rules. Applying the one or more rules to the information related to the transaction can further comprise selecting the one or more rules from a set of rules based on a source of the information related to the transaction, a type of the transaction, identity of one or more parties to the transaction, or other information related to the transaction. In response to determining that payment of the transaction is doubtful the portion of the account receivable corresponding to the transaction can be written off.

The instructions can also cause the processor to maintain a funded reserve account related to a party to the transaction. In such a case, writing off the portion of the account receivable corresponding to the transaction can further comprise debiting the reserve account an amount equal to the portion of the account receivable written off, recalculating a balance of an open invoice related to the transaction, updating a general ledger in which the account receivable is recorded to indicate write off of the transaction, and updating the account receivable to indicate write off of the transaction. The general ledger in which the account receivable is recorded may be updated, for example, as part of a periodic batch process.

In some cases, the instructions can also cause the processor to receive information related to the transaction indicating payment of at least a portion of the transaction. In such a case, the instructions can also cause the processor to credit the reserve account an amount equal to the payment, update the general ledger in which the account receivable is recorded, flag an accounts receivable transaction related to the payment as a return, and update the accounts receivable with the flagged accounts receivable transaction. Updating the general ledger in which the account receivable is recorded can be performed, for example, as part of a periodic, e.g., daily, batch process.

According to yet another embodiment, a machine-readable medium can have stored thereon a series of instructions which, when executed by a processor, cause the processor to process unfunded financial transaction by receiving information related to a transaction. The transaction can correspond to at least a portion of an account receivable. One or more rules can be applied to the information related to the transaction and a determination can be made as to whether payment of the transaction is doubtful based on application of the one or more rules. Applying the one or more rules to the information related to the transaction can further comprise selecting the one or more rules from a set of rules based on a source of the information related to the transaction, a type of the transaction, identity of one or more parties to the transaction, or other information related to the transaction. In response to determining that payment of the transaction is doubtful the portion of the account receivable corresponding to the transaction can be written off.

A funded reserve account related to a party to the transaction can also be maintained. In such a case, writing off the portion of the account receivable corresponding to the transaction can further comprise debiting the reserve account an amount equal to the portion of the account receivable written off, recalculating a balance of an open invoice related to the transaction, updating a general ledger in which the account receivable is recorded to indicate write off of the transaction, and updating the account receivable to indicate write off of the transaction. The general ledger in which the account receivable is recorded may be updated, for example, as part of a periodic batch process.

In some cases, information related to the transaction indicating payment of at least a portion of the transaction can be received. In such a case, the reserve account can be credited an amount equal to the payment, the general ledger in which the account receivable is recorded can be updated, an accounts receivable transaction related to the payment can be flagged as a return, and the accounts receivable can be updated with the flagged accounts receivable transaction. Updating the general ledger in which the account receivable is recorded can be performed, for example, as part of a periodic batch process.

According to one embodiment, maintaining the funded reserve account can further comprise determining whether a balance of the reserve account falls below a minimum amount designated for the reserve account and, in response to determining the balance of the reserve account falls below the minimum amount designated to the reserve account, recovering an amount to replenish the reserve account and crediting the reserve account for the amount recovered. Alternatively or additionally, maintaining the reserve account can comprise determining whether interest is earned on the reserve account. Determining whether interest is earned on the reserve account can be based on applying a rule of the one or more rules. In response to determining interest is earned on the reserve account, an amount of interest earned can be determined. Determining the amount of interest earned can be based on a table of information related to the reserve account. The interest earned can be handled or applied based on a rule of the one or more rules. For example, handling the interest can comprise returning the interest to the party to the transaction or crediting the amount of interest to the reserve account.

In some cases, a determination can be made as to whether to charge a write off fee for the transaction. In response to determining the charge the write off fee for the transaction, determining the write off fee and debiting the reserve account an amount equal to the write off fee. Determining whether to charge a write off fee can be based on applying a rule of the one or more rules. The write off fee can be determined based of a table of information related to the party to the transaction.

### BRIEF DESCRIPTION OF THE DRAWINGS

FIG. 1 is a block diagram illustrating an exemplary environment in which embodiments of the present invention may be implemented.

FIG. 2 is a block diagram illustrating an exemplary computer system upon which embodiments of the present invention may be implemented.

FIG. 3 is a block diagram illustrating functional components of a system for processing unfunded financial transactions according to one embodiment of the present invention.

FIG. 4 is a flow chart illustrating a process for receiving information related to a financial transaction according to one embodiment of the present invention.

FIG. 5 is a flow chart illustrating processing of information related to a financial transaction according to one embodiment of the present invention.

FIG. 6 is a flow chart illustrating a write off process according to one embodiment of the present invention.

FIG. 7 is a flow chart illustrating a recovery process according to one embodiment of the present invention.

FIG. 8 is a flow chart illustrating a process for maintaining a funded reserve account according to one embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the invention provide methods and systems for processing or handling unfunded financial transactions. In some such embodiments, the processes are executed by an entity, for example an acquirer, on behalf of one or more client organizations. The description below sometimes provides illustrations that use an example where a client organization is a financial institution, but there is no such requirement for the invention and the methods are intended also to be applicable to other types of organizations that make use of large collections of data.

The description herein sometimes refers to “clients” and to “customers.” Reference to “clients” is intended to refer to persons, i.e. individuals, entities, or their agents, on whose behalf a set of information is managed and/or transactions are conducted. Reference to “customers” or “consumer” is intended to refer to persons, i.e. individuals, entities, or their agents, who are the subject of or related to that information. Thus, merely for purposes of illustration, in the case where the information comprises credit-card account records for a credit card issued to Mr. Jones by Bank A, Bank A corresponds to a client and Mr. Jones corresponds to a customer or consumer.

In describing embodiments of the invention, reference is sometimes made to other terms having specific intended meanings. For example, as used herein, the term “payment network” refers herein to an infrastructure that supports that exchange of data in implementing payment transactions. It is anticipated that the data exchange typically proceeds between merchants and financial institutions. Examples of existing commercial networks that are included within the definition of “payment network” include the STAR/MAC network, the NYCE® network, the VISA® network, and the MasterCard® network. Access to a network by a consumer can be achieved through entry of a secret code, such as a personal identification number (“PIN”), in combination with data extracted from the magnetic stripe of a card. In some embodiments, a signature of the consumer may be used in lieu of a secret code. In some instances, particularly in support of transactions having a low value, a consumer might be permitted access to the payment network with only information extracted from the mobile device, without the need to provide a PIN or signature.

The term “payment vehicle” is used herein to refer to a method of payment. For example, payment vehicles can include, but are not limited to credit, debit, stored-value, checks and other types of accounts. In some embodiments, a payment vehicle can include loyalty points or other value accumulated, for example, under a loyalty program.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

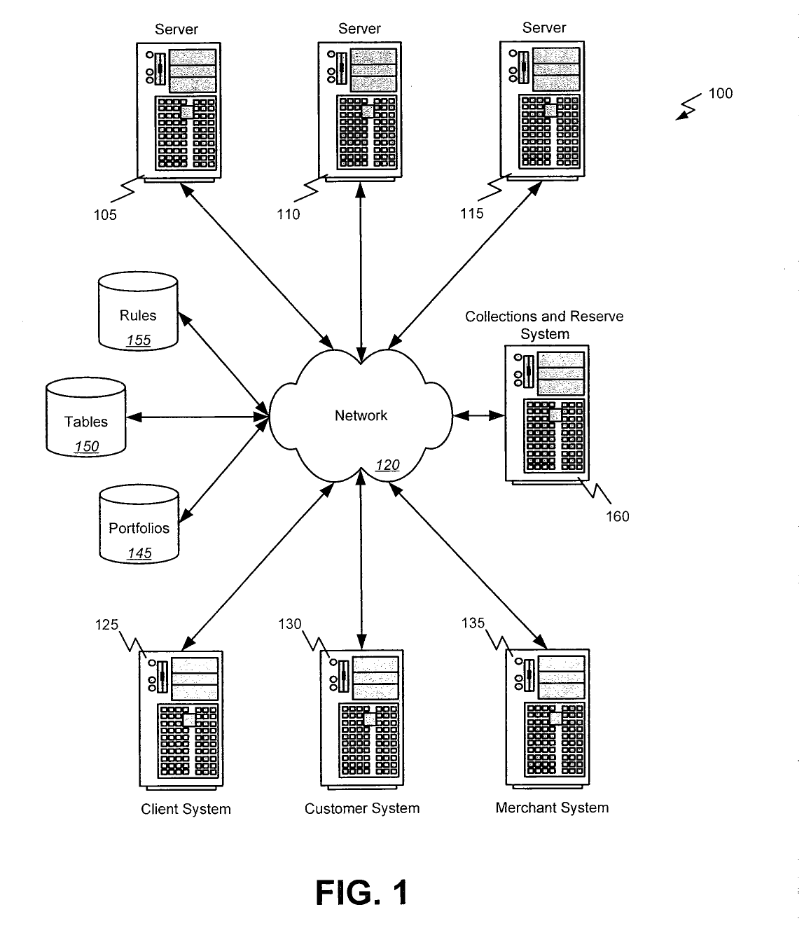

FIG. 1 is a block diagram illustrating an exemplary environment in which embodiments of the present invention may be implemented. In this example, the system can include one or more server computers 105, 110, 115 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to execute a plurality of processes related to financial transactions of one or more consumers on behalf of one or more client financial institutions. For example, one or more of the servers 105, 110, 115 may execute one or more processes for recording transactions on a credit card issued to the consumer by the financial institution. Other processes may provide for paying a merchant for the consumer's purchase, billing the consumer, etc The applications can also include any number of applications for controlling access to resources of the servers 105, 110, 115.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system 100 can include one or more user computers which may be used to operate a client, whether a dedicate application, web browser, etc. For example, the user computers can include a client system 125 operated by a client financial institution, a customer system 130 operated by a customer or consumer, a merchant system 135 operated by a merchant or vendor, etc. The user computers 125, 130, 135 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 125, 130, 135 may also have any of a variety of applications, including one or more development systems, database client and/or server applications, and web browser applications. Alternatively, the user computers 125, 130, 135 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with three user computers, any number of user computers may be supported.

The system 100 may also include one or more databases or repositories 145-155 of data such as a set of rules 155, tables 150 and portfolios for one or more entities 145. The database(s) 145-155 may reside in a variety of locations. By way of example, a databases 145-155 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the databases 145-155 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the databases 145-155 may be a relational database that is adapted to store, update, and retrieve data in response to SQL-formatted commands. The databases 145-155 can include a wide variety of information related to financial transactions related to the consumer and/or specified by different entities such as merchants, financial institutions, third-party advertisers, etc.

According to one embodiment, the system 100 can also include a collections and reserve system 160 communicatively coupled with the network 120. The collections and reserve system 160 may be operated, for example, by an acquirer participating in handling or processing financial transactions involving the client system 125, customer system 130, and/or the merchant system 135. One or more of the servers 105-115 can also be operated by the acquirer and can record information related to the transaction. For example, in the case an unfunded transaction, one of the servers 105 can record the transaction as an account receivable to indicate the financial liability to the acquirer.

As will be described in greater detail below, the collections and reserve system 160 can be adapted to receive information related to the transaction. For example, the server 105 operated by the acquirer and maintaining an account receivable related to the transaction between the customer and the merchant can provide such information to the collections and reserve system 160. This information may be provided periodically or based on some other criteria. For example, the server 105 may provide the transaction information to the collections and reserve system 160 based on some aging or other criteria related to the account receivable indicating that it remains unpaid.

Upon receiving the transaction information, the collections and reserve system 160 can read one or more rules from the repository of rules 155. That is, one or more rules can be selected to be applied to the transaction information. Selection of one or more rules can be based on a source of the information related to the transaction, i.e., the server 105 providing the information, a type of the transaction, e.g., a credit card transaction, a check, etc., identity of one or more parties to the transaction, such as the merchant, the customer, etc., or other information related to the transaction. One or more selected rules can then be applied to the information related to the transaction by the collections and reserve system 160 and a determination can be made as to whether payment of the transaction is doubtful based on application of the one or more rules. In response to determining that payment of the transaction is doubtful, the collections and reserve system can write off the portion of the account receivable corresponding to the transaction. That is, the account receivable and related general ledger entries can be adjusted to indicate a write off of the transaction.

As will be seen, the collections and reserve system 160 can also maintain a funded reserve account related to a party to the transaction such as the merchant. In such a case, writing off the portion of the account receivable corresponding to the transaction can further comprise debiting the reserve account an amount equal to the portion of the account receivable written off, recalculating a balance of an open invoice related to the transaction, updating a general ledger in which the account receivable is recorded to indicate write off of the transaction, and updating the account receivable to indicate write off of the transaction. The general ledger in which the account receivable is recorded may be updated, for example, as part of a periodic batch process.

However, even if a transaction or portion of an account receivable is written off, the collections and reserve system 160 can maintain a record of that write off. In this way, the matter is not truly closed. Rather, this information may be made available to other systems and/or entities (not shown here). For example, information related to written off transactions can be made available to collectors to attempt to recover some or all of the written off amount.

In some cases, for example after the write off amount has been collected or paid, the collections and reserve system 160 can receive information related to the transaction indicating payment of at least a portion of the transaction. In such a case, the collections and reserve system 160 can credit the reserve account an amount equal to the payment, update the general ledger in which the account receivable is recorded, flag an accounts receivable transaction related to the payment as a return, and update the accounts receivable with the flagged accounts receivable transaction. Updating the general ledger in which the account receivable is recorded can be performed, for example, as part of a periodic batch process.

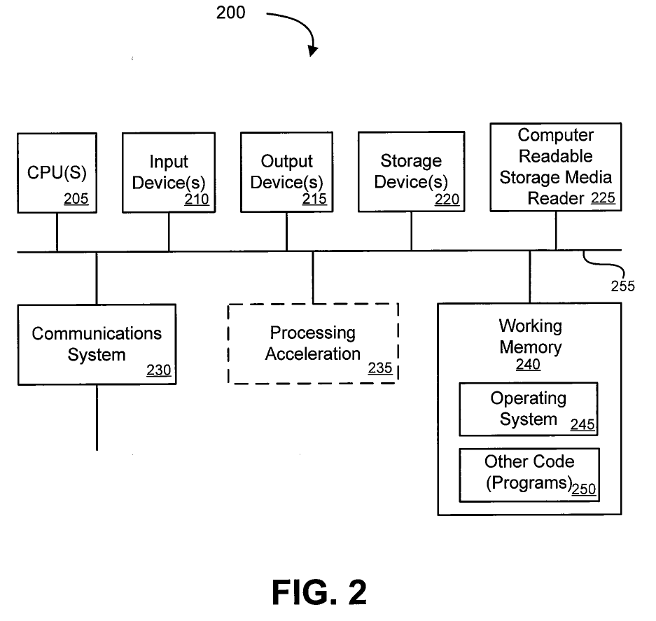

FIG. 2 is a block diagram illustrating an exemplary computer system upon which various elements of the exemplary environment illustrated in FIG. 1 may be implemented. The computer system 200 is shown comprising hardware elements that may be electrically coupled via a bus 255. The hardware elements may include one or more central processing units (CPUs) 205; one or more input devices 210 (e.g., a scan device, a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above communicatively coupled with and readable by CPU(s) 205. In some embodiments, the computer system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer or other type of device.

The computer system 200 may also comprise software elements, shown as being currently located within a working memory 240, including an operating system 245 and/or other code 250, such as an application program. The application programs may implement the methods of the invention as described herein. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

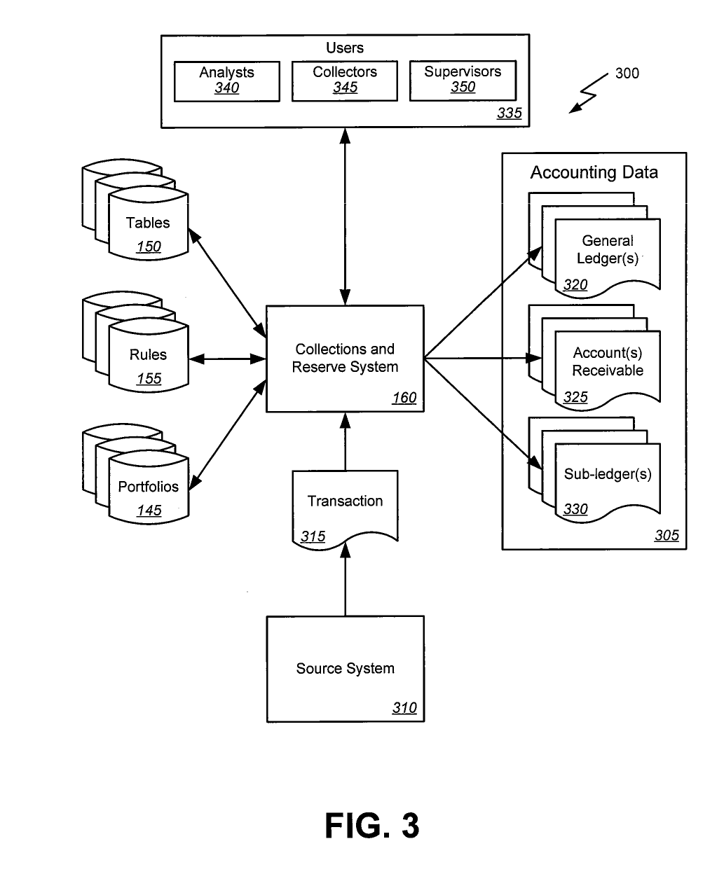

FIG. 3 is a block diagram illustrating functional components of a system for processing unfunded financial transactions according to one embodiment of the present invention. As noted above, the collections and reserve system 160 can be adapted to receive information 315 related to a transaction from a source system 310. For example, a server operated by the acquirer and maintaining an account receivable related to the transaction between the customer and the merchant can provide such information 315 to the collections and reserve system 160. This information 315 may be provided periodically or based on some other criteria. For example, the source system 310 may provide the transaction information 315 to the collections and reserve system 160 based on some aging or other criteria related to the account receivable indicating that it remains unpaid.

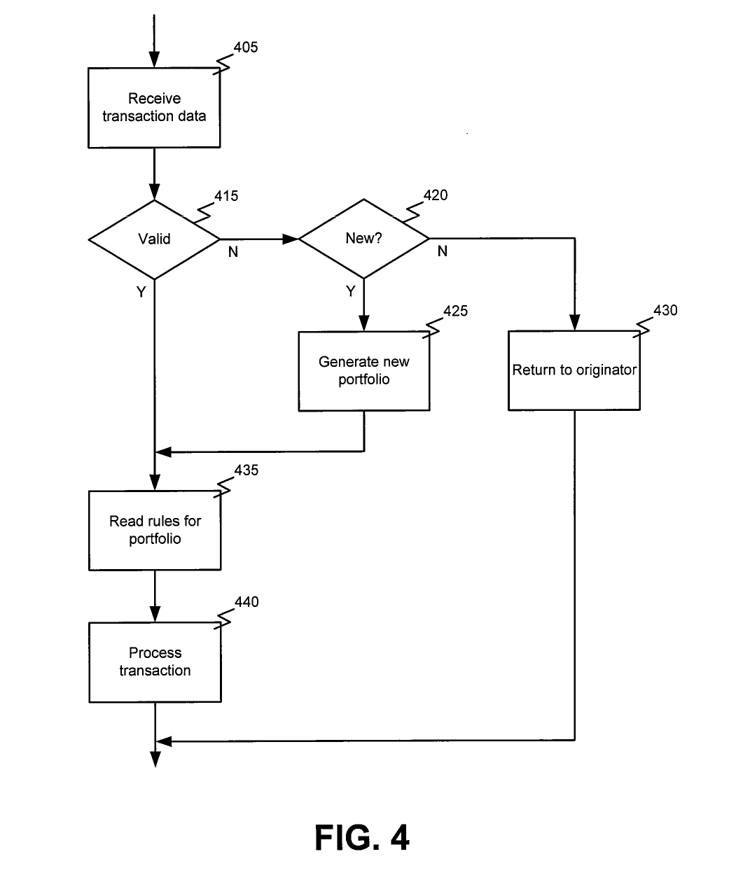

Upon receiving the transaction information 315, the collections an reserve system 160 may first validate the information receives. For example, the collections and reserve system 160 can check to determine whether the transaction information 315 is related information stored in a portfolio repository 145. Information in the portfolio repository can identify one or more parties or other entities known to the acquirer system such as merchants, consumers, issuing financial institutions or others and can include information defining handling of transactions and/or reserve accounts related to that party. If the transaction information 315 is not related to one of the portfolios, the collections and reserve system 160 may provide a utility for adding or generating a new portfolio based on a template or form. Additional details of the process of receiving transaction information will be discussed below with reference to FIG. 4.

Upon receiving and identifying the transaction information 315, the collections and reserve system 160 can read one or more rules from the repository of rules 155. That is, one or more rules can be selected to be applied to the transaction information 315. Selection of one or more rules can be based on a source of the information related to the transaction, i.e., the server 105 providing the information, a type of the transaction, e.g., a credit card transaction, a check, etc., identity of one or more parties to the transaction, such as the merchant, the customer, etc., or other information related to the transaction. Such identifying information may be provided by the transaction information 315 or by the portfolio 145 identified for that transaction information.

One or more selected rules can then be applied to the information related to the transaction by the collections and reserve system 160 and a determination can be made as to whether payment of the transaction is doubtful based on application of the one or more rules. In response to determining that payment of the transaction is doubtful, the collections and reserve system 160 update accounting information 305 to affect a write off of the portion of the account receivable 325 corresponding to the transaction. That is, the account receivable 325 and related general ledger 320 entries can be adjusted to indicate a write off of the transaction.

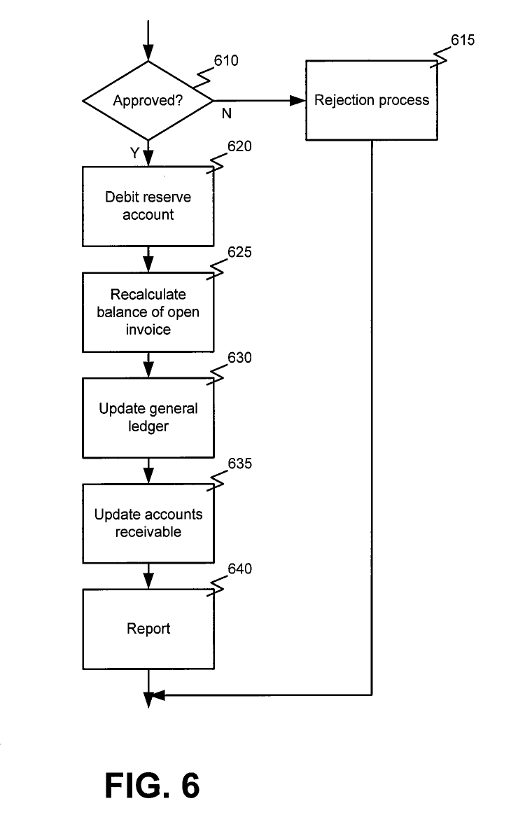

As will be seen, the collections and reserve system 160 can also maintain a funded reserve account, maintained for example in a sub-ledger 330, related to a party to the transaction such as the merchant. In such a case, writing off the portion of the account receivable 325 corresponding to the transaction can further comprise debiting the reserve account sub-ledger 330 an amount equal to the portion of the account receivable 325 written off, recalculating a balance of an open invoice related to the transaction, updating a general ledger 320 in which the account receivable is recorded to indicate write off of the transaction, and updating the account receivable 325 to indicate write off of the transaction. The general ledger 320 in which the account receivable is recorded may be updated, for example, as part of a periodic batch process. Additional details of an exemplary write off process will be described below with reference to FIG. 6.

According to one embodiment, the collections and reserve system 160 can also determining whether to charge a write off fee for the transaction. Determining whether to charge a write off fee can be based on applying a rule of the one or more rules selected. The write off fee can be determined based of a table 150 of information related to the reserve account and/or the identified portfolio 145. Among other possible information, the table can identify fees, interest rates, due dates, time limits, transaction types, and other information related to handling of transactions for the portfolio. In response to determining the charge the write off fee for the transaction, the collections and reserve system 160 can calculate the write off fee and debit the reserve account, i.e., make a debit entry in the sub-ledger 330 for, an amount equal to the write off fee.

Even if a transaction or portion of an account receivable is written off, the collections and reserve system 160 can maintain a record of that write off, for example in the sub-ledge 330 related to the transaction. In this way, the matter is not truly closed. Rather, this information may be made available to other systems and/or entities. For example, information related to written off transactions can be made available to collectors 345, analysts 340, supervisors and other users 335. That is, the collections and reserve system 160, through a graphical or other interface, can provide different types of users 335 views of the accounting information 305 including the sub-ledgers 330 related to write offs. In this way, the various users can access the accounting information 305, manage and/or analyze the information, and/or attempt to recover some or all of the written off transaction.

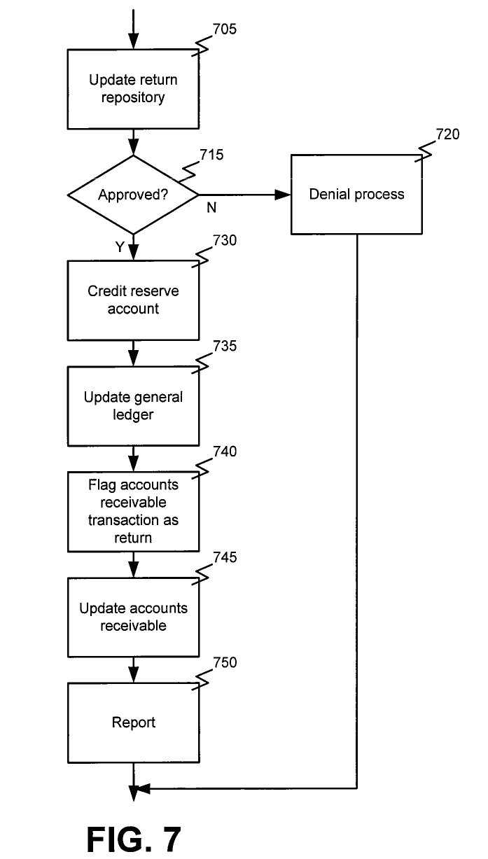

In some cases, for example after the write off amount has been collected or paid, the collections and reserve system 160 can receive information related to the transaction indicating payment of at least a portion of the transaction. In such a case, the collections and reserve system 160 can credit the reserve account sub-ledger 330 an amount equal to the payment, update the general ledger 320 in which the account receivable is recorded, flag an accounts receivable transaction related to the payment as a recovery, and update the accounts receivable 325 with the flagged accounts receivable transaction. Updating the general ledger 320 in which the account receivable is recorded can be performed, for example, as part of a periodic batch process. Additional details of an exemplary recovery process will be described below with reference to FIG. 7.

According to one embodiment, the collections and reserve system 160 can also be adapted to maintain a reserve account, i.e., indicated by a sub-ledger 330, by determining whether a balance of the reserve account falls below a minimum amount designated for the reserve account, for example by information stored in a table 150 related to that reserve account. In response to determining the balance of the reserve account falls below the minimum amount designated to the reserve account, an amount can be recovered to replenish the reserve account. For example, the collection and reserve system may request replenishment from a party such as a merchant associated with the reserve account. Upon receipt of the replenishment amount, the collections and reserve system 160 can credit the reserve account for the amount recovered.

Alternatively or additionally, maintaining the reserve account can comprise determining whether interest is earned on the reserve account. The collections and reserve system 160 can determining whether interest is earned on the reserve account can be based on applying a rule of the one or more rules 155 related to the portfolio 145. In response to determining interest is earned on the reserve account, an amount of interest earned can be determined. Determining the amount of interest earned can be based, for example on an interest rate, schedule, flat fee, or other information from a table of information 150 related to the reserve account. The interest earned can be handled or applied based on a rule of the one or more rules. For example, handling the interest can comprise returning the interest to the party to the transaction, e.g., the merchant, or crediting the amount of interest to the sub-ledger 330 for the reserve account.

FIG. 4 is a flow chart illustrating a process for receiving information related to a financial transaction according to one embodiment of the present invention. In this example, processing begins with receiving 405 information related to a financial transaction. The received information can be validated 415. That is, the information can be checked to determine 415 is related to an established portfolio. If 415 the information is not valid, a determination 420 can be made as to whether a new portfolio should be generated. This determination 420 can be based, for example, on a query presented to a user or administrator. If 420 a determination is made to generate a new portfolio, a new portfolio can be generated 425 based on the received transaction information as well as information supplied by the user or administrator. The generation process 425 can include generating the tables and rules related to the portfolio and as described above. If 420 a determination is made to not generate a new portfolio, the transaction information may be returned 430 to the originator or sender of the information, perhaps with an error or other message.

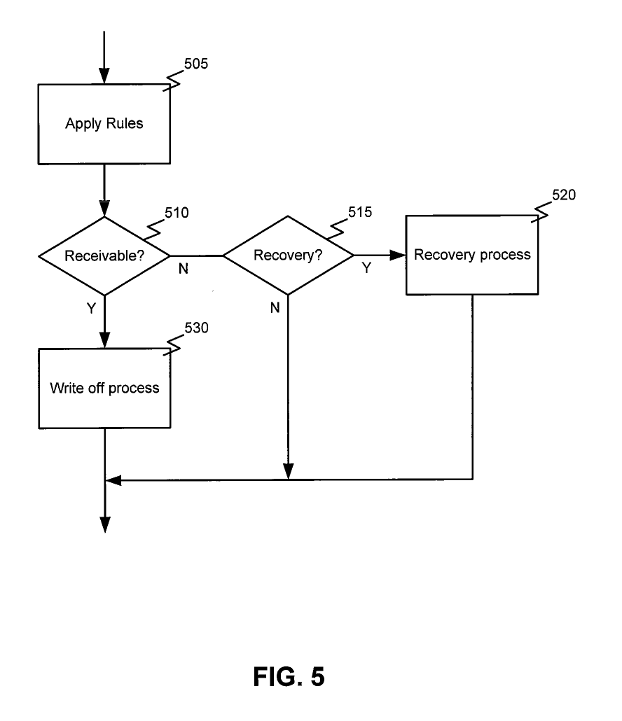

If 415 the transaction information is found to be valid or after generating 425 a new portfolio, one or more rules for the portfolio can be read 435. Each of these rules can comprise a logical combination of at least one condition and at least one corresponding action. As such, the rules can define how information related to a transaction for a particular portfolio can be handled. For example and as described above, rules for a portfolio can define how a determination is made to write off a particular transaction, whether to charge a write off fee or apply interest to the reserve account, etc. Once these rule(s) are read 435, the transaction information can be processed 440 accordingly. Details of processing the transaction information will now be described with reference to FIGS. 5-7.

FIG. 5 is a flow chart illustrating processing of information related to a financial transaction according to one embodiment of the present invention. In this example, the process begins with applying 505 one or more rules to the transaction information. Based on application 505 of the rule(s), determinations 510 and 515 can be made as to how to handle the transaction information. For example, a determination 510 can be made as to whether the transaction information indicates or relates to an account receivable that should be written off. If 510 the transaction information indicates or relates to an account receivable that should be written off, a write off process 530 can be performed. An exemplary write off process 530 will be described below with reference to FIG. 6. Alternatively, a determination 515 can be made as to whether the transaction information represents a repayment or recovery of an account previously written off. If 515 the transaction information represents a repayment or recovery of an account previously written off, a recovery 520 process can be performed. An exemplary recovery process 520 will be described below with reference to FIG. 7.

FIG. 6 is a flow chart illustrating a write off process according to one embodiment of the present invention. In this example, the process can begin with obtaining 610 approval for the transaction, i.e., the write off. Obtaining 610 approval can comprise, for example, presenting query to a user or administrator with information related to the transaction and/or portfolio related to the transaction and accepting an indication of approval or denial. If 610 not approved a rejection process 615 can be performed such as, for example, returning an error or other message to the originator of the transaction information.

If 610 the transaction is approved, the reserve account can be debited 620 an amount equal to the portion of the account receivable written off. That is, a sub-ledger relating to the reserve account can be debited 620 to reflect the write off. A balance of an open invoice related to the transaction can be recalculated 625 and a general ledger in which the account receivable is recorded can be updated 630 to indicate write off of the transaction. As noted above, rather that being performed in real-time or near real-time, the general ledger in which the account receivable is recorded may be updated, for example, as part of a periodic batch process. The account receivable related to the transaction can be updated 635 to indicate write off of the transaction. A report of the write off can be generated 640 and/or displayed, recorded, printed, etc.

FIG. 7 is a flow chart illustrating a recovery process according to one embodiment of the present invention. In this example, the process begins with updating 705 a return repository. That is, a record can be made of the return or recovery transaction. Approval can be obtained 715 for the transaction, i.e., the recovery. Obtaining 715 approval can comprise, for example, presenting query to a user or administrator with information related to the transaction and/or portfolio related to the transaction and accepting an indication of approval or denial. If 715 not approved a denial process 720 can be performed such as, for example, returning an error or other message to the originator of the transaction information.

If 715 the transaction is approved, the reserve account can be credited 730 an amount equal to the payment. That is, a sub-ledger relating to the reserve account can be credited 730 to reflect the recovery. The general ledger in which the account receivable is recorded can be updated 735, i.e., credited, to reflect the recovery. As noted above, rather that being performed in real-time or near real-time, the general ledger in which the account receivable is recorded may be updated, for example, as part of a periodic batch process. An accounts receivable transaction related to the payment can be generated and flagged 740 as a return and the accounts receivable can be updated 745 with the flagged accounts receivable transaction. A report of the recovery can be generated 750 and/or displayed, recorded, printed, etc.

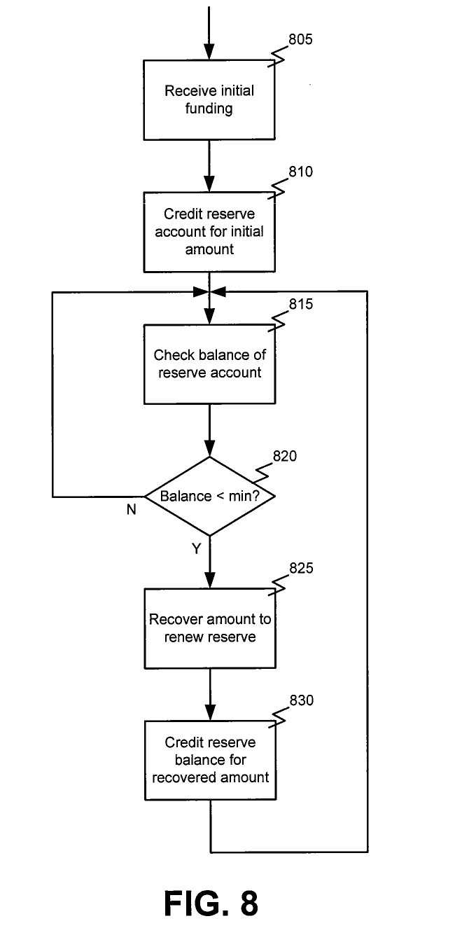

FIG. 8 is a flow chart illustrating a process for maintaining a funded reserve account according to one embodiment of the present invention. In this example, the process begins with receiving 805 an initial funding amount for the reserve account and crediting 810 the reserve account, i.e., a sub-ledger related to the reserve account, for the initial amount. Once the reserve account has been funded, it may be credited and debited based on write offs and recoveries as described above. Therefore, the balance of the reserve account can be checked 815. This check 815 can be made periodically, each time the reserve account is debited, or on the occurrence of another event. A determination 820 can be made as to whether the balance of the reserve account falls below a minimum amount designated for the reserve account, for example in one of the tables associated with the portfolio of the reserve account. In response to determining 820 the balance of the reserve account falls below the minimum amount designated to the reserve account, an amount can be recovered 825 to replenish the reserve account. For example, the collection and reserve system may request replenishment from a party such as a merchant associated with the reserve account. Upon receipt of the renewal amount. the reserve account can be credited for the amount received.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of processing unfunded financial transactions, the method comprising:
receiving information related to a transaction, the transaction corresponding to at least a portion of an account receivable;
applying one or more rules to the information related to the transaction;
determining whether payment of the transaction is doubtful based on application of the one or more rules; and
in response to determining that payment of the transaction is doubtful, writing off the portion of the account receivable corresponding to the transaction.

2. The method of claim 1, further comprising maintaining a funded reserve account related to a party to the transaction.

3. The method of claim 2, wherein writing off the portion of the account receivable corresponding to the transaction further comprises:
debiting the reserve account an amount equal to the portion of the account receivable written off;
recalculating a balance of an open invoice related to the transaction;
updating a general ledger in which the account receivable is recorded to indicate write off of the transaction; and
updating the account receivable to indicate write off of the transaction.

4. The method of claim 3, wherein updating the general ledger in which the account receivable is recorded is performed as part of a periodic batch process.

5. The method of claim 3, further comprising:
determining whether to charge a write off fee for the transaction; and
in response to determining to charge the write off fee for the transaction, determining the write off fee and debiting the reserve account an amount equal to the write off fee.

6. The method of claim 5, wherein determining whether to charge a write off fee is based on applying a rule of the one or more rules.

7. The method of claim 5, wherein the write off fee is determined based on a table of information related to the party to the transaction.

8. The method of claim 3, further comprising reporting information related to the transaction.

9. The method of claim 8, wherein reporting the information related to the transaction comprises providing the information to a collector.

10. The method of claim 2, further comprising receiving information related to the transaction indicating payment of at least a portion of the transaction.

11. The method of claim 10, further comprising:
crediting the reserve account an amount equal to the payment;
updating the general ledger in which the account receivable is recorded;
flagging an accounts receivable transaction related to the payment as a return; and
updating the accounts receivable with the flagged accounts receivable transaction.

12. The method of claim 11, wherein updating the general ledger in which the account receivable is recorded is performed as part of a periodic batch process.

13. The method of claim 1, wherein applying the one or more rules to the information related to the transaction further comprises selecting the one or more rules from a set of rules based on a source of the information related to the transaction.

14. The method of claim 1, wherein applying the one or more rules to the information related to the transaction further comprises selecting the one or more rules from a set of rules based on a type of the transaction.

15. The method of claim 1, wherein applying the one or more rules to the information related to the transaction further comprises selecting the one or more rules from a set of rules based on a party to the transaction.

16. The method of claim 2, wherein maintaining the funded reserve account further comprises:
determining whether a balance of the reserve account falls below a minimum amount designated for the reserve account; and
in response to determining the balance of the reserve account falls below the minimum amount designated to the reserve account, recovering an amount to replenish the reserve account and crediting the reserve account for the amount recovered.

17. The method of claim 2, wherein maintaining the reserve account comprises determining whether interest is earned on the reserve account.

18. The method of claim 17, wherein determining whether interest is earned on the reserve account is based on applying a rule of the one or more rules.

19. The method of claim 17, further comprising, in response to determining interest is earned on the reserve account, determining an amount of interest earned.

20. The method of claim 19, wherein determining the amount of interest earned is based on a table of information related to the reserve account.

21. The method of claim 19, further comprising handling the interest earned based on a rule of the one or more rules.

22. The method of claim 21, wherein handling the interest comprises returning the interest to the party to the transaction.

23. The method of claim 21, wherein handling the interest comprises crediting the amount of interest to the reserve account.

24. A system for processing an unfunded financial transaction, the system comprising:
a repository having stored therein a plurality of rule sets, wherein at least one rule set of the plurality of rule sets is associated with a party to the financial transaction;
a processor communicatively coupled with the repository; and
a memory communicatively coupled with and readable by the processor and having stored therein a series of instructions that, when executed by the processor, causes the processor to receive information related to the transaction, the transaction corresponding to at least a portion of an account receivable, apply one or more rules of the rule set associated with the party to the financial transaction to the information related to the transaction, determine whether payment of the transaction is doubtful based on application of the one or more rules, and in response to determining that payment of the transaction is doubtful, write off the portion of the account receivable corresponding to the transaction.

25. The system of claim 24, wherein the processor further maintains a funded reserve account related to a party to the transaction.

26. The system of claim 25, wherein writing off the portion of the account receivable corresponding to the transaction further comprises:
debiting the reserve account an amount equal to the portion of the account receivable written off;
recalculating a balance of an open invoice related to the transaction;
updating a general ledger in which the account receivable is recorded to indicate write off of the transaction; and
updating the account receivable to indicate write off of the transaction.

27. The system of claim 26, wherein updating the general ledger in which the account receivable is recorded is performed as part of a periodic batch process.

28. The system of claim 26, wherein the processor further:
determines whether to charge a write off fee for the transaction; and
in response to determining to charge the write off fee for the transaction, determines the write off fee and debiting the reserve account an amount equal to the write off fee.

29. The system of claim 28, wherein determining whether to charge a write off fee is based on applying one or more rules of the rule set associated with the party to the financial transaction to the information related to the transaction.

30. The system of claim 28, wherein the system further comprises a plurality of tables, wherein at least one table of the plurality of tables is associated with the party to the transaction and the write off fee is determined based on the table related to the party to the transaction.

31. The system of claim 26, wherein the processor further reports information related to the transaction.

32. The system of claim 31, wherein reporting the information related to the transaction comprises providing the information to a collector.

33. The system of claim 25, wherein the processor further receives information related to the transaction indicating payment of at least a portion of the transaction.

34. The system of claim 33, wherein the processor further:
credits the reserve account an amount equal to the payment;
updates the general ledger in which the account receivable is recorded;
flags an accounts receivable transaction related to the payment as a return; and
updates the accounts receivable with the flagged accounts receivable transaction.

35. The system of claim 34, wherein updating the general ledger in which the account receivable is recorded is performed as part of a periodic batch process.

36. The system of claim 24, wherein applying the one or more rules to the information related to the transaction further comprises selecting the one or more rules from a set of rules based on a source of the information related to the transaction.

37. The system of claim 24, wherein applying the one or more rules to the information related to the transaction further comprises selecting the one or more rules from a set of rules based on a type of the transaction.

38. The system of claim 24, wherein applying the one or more rules to the information related to the transaction further comprises selecting the one or more rules from a set of rules based on a party to the transaction.

39. A machine-readable medium having stored thereon a series of instructions that, when executed by a processor, causes the processor to process unfunded financial transaction by:
receiving information related to a transaction, the transaction corresponding to at least a portion of an account receivable;
applying one or more rules to the information related to the transaction;
determining whether payment of the transaction is doubtful based on application of the one or more rules; and
in response to determining that payment of the transaction is doubtful, writing off the portion of the account receivable corresponding to the transaction.

40. The machine-readable medium of claim 39, further comprising maintaining a funded reserve account related to a party to the transaction.

41. The machine-readable medium of claim 40, wherein writing off the portion of the account receivable corresponding to the transaction further comprises:
debiting the reserve account an amount equal to the portion of the account receivable written off;
recalculating a balance of an open invoice related to the transaction;
updating a general ledger in which the account receivable is recorded to indicate write off of the transaction; and
updating the account receivable to indicate write off of the transaction.

42. The machine-readable medium of claim 41, wherein updating the general ledger in which the account receivable is recorded is performed as part of a periodic batch process.

43. The machine-readable medium of claim 41, further comprising:
determining whether to charge a write off fee for the transaction; and
in response to determining the charge the write off fee for the transaction, determining the write off fee and debiting the reserve account an amount equal to the write off fee.

44. The machine-readable medium of claim 43, wherein determining whether to charge a write off fee is based on applying a rule of the one or more rules.

45. The machine-readable medium of claim 43, wherein the write off fee is determined based of a table of information related to the party to the transaction.

46. The machine-readable medium of claim 41, further comprising reporting information related to the transaction.

47. The machine-readable medium of claim 46, wherein reporting the information related to the transaction comprises providing the information to a collector.

48. The machine-readable medium of claim 40, further comprising receiving information related to the transaction indicating payment of at least a portion of the transaction.

49. The machine-readable medium of claim 48, further comprising:
crediting the reserve account an amount equal to the payment;
updating the general ledger in which the account receivable is recorded;
flagging an accounts receivable transaction related to the payment as a return; and
updating the accounts receivable with the flagged accounts receivable transaction.

50. The machine-readable medium of claim 49, wherein updating the general ledger in which the account receivable is recorded is performed as part of a periodic batch process.

51. The machine-readable medium of claim 39, wherein applying the one or more rules to the information related to the transaction further comprises selecting the one or more rules from a set of rules based on a source of the information related to the transaction.

52. The machine-readable medium of claim 39, wherein applying the one or more rules to the information related to the transaction further comprises selecting the one or more rules from a set of rules based on a type of the transaction.

53. The machine-readable medium of claim 39, wherein applying the one or more rules to the information related to the transaction further comprises selecting the one or more rules from a set of rules based on a party to the transaction.

54. The machine-readable medium of claim 40, wherein maintaining the funded reserve account further comprises:
determining whether a balance of the reserve account falls below a minimum amount designated for the reserve account; and
in response to determining the balance of the reserve account falls below the minimum amount designated to the reserve account, recovering an amount to replenish the reserve account and crediting the reserve account for the amount recovered.

55. The machine-readable medium of claim 40, wherein maintaining the reserve account comprises determining whether interest is earned on the reserve account.

56. The machine-readable medium of claim 55, wherein determining whether interest is earned on the reserve account is based on applying a rule of the one or more rules.

57. The machine-readable medium of claim 55, further comprising, in response to determining interest is earned on the reserve account, determining an amount of interest earned.

58. The machine-readable medium of claim 57, wherein determining the amount of interest earned is based on a table of information related to the reserve account.

59. The machine-readable medium of claim 57, further comprising handling the interest earned based on a rule of the one or more rules.

60. The machine-readable medium of claim 59, wherein handling the interest comprises returning the interest to the party to the transaction.

61. The machine-readable medium of claim 59, wherein handling the interest comprises crediting the amount of interest to the reserve account.
